(19) United States
(12) Patent Application Publication
(10) Pub. No.: US 2010/0114164 A1
(43) Pub. Date: May 6, 2010

(54) Pacifier holder

(76) Inventor: Chris Thomas, Plano, TX (US)

Correspondence Address: Chris Thomas, 5920 Loch Maree, Plano, TX, 75093, US

(21) Appl. No.: 12/290,994

(22) Filed: Nov. 6, 2008

(51) Int. Cl. A61J 17/00; A44B 18/00

(52) U.S. Cl. 606/234; 24/306

(57) ABSTRACT

A pacifier holder with a clamping device, a pacifier, a pacifier holding ring, a flexible wire form, a wire form to pacifier connector member and a polyfoam tube covering the wire form. The wire form terminates at each end in a threaded portion. One threaded portion engages with female threads in the connector member. The other the threaded portion engages the clamping device. The connector member has a male thread that can engage a mating female thread portion located on the rear of the pacifier holder ring. The pacifier holder ring includes a circular base plate and a side perimeter ring, and the side perimeter ring which can removably retain the pacifier. A preferred embodiment includes a clamping device that has slidably connected top and bottom plates and a screw down plate that locks the pacifier holder onto the frame of a chair or bed.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of baby accessories and more specifically to a pacifier holder.

Pacifiers are well known in the world of infants. They traditionally are comprised of a nipple portion and a plastic face plate or base plate portion. It is a common problem for care givers of infants to have to pick up and clean pacifiers when an infant drops it. It is also frustrating for the infant when the pacifier is wanted and is not provided by the care giver.

To remedy this problem a number of products have been introduced to help keep the pacifier in close proximity to the infant. One such solution is to attach a short leash to the pacifier and attach the other end to the infants clothing or to a stroller or bed. However there is a deficiency in the prior technology in that a leash can become dangerously tangled around the infant's neck.

Additionally, when the pacifier is dropped by a young infant, he or she may not have the awareness or motor skills to locate it, even though it is in relatively close proximity to the infant.

### BRIEF SUMMARY OF THE INVENTION

The primary object of the invention is to provide a pacifier holder that can be removably attached to a car seat, stroller, bed or chair that allows an infant to have easy access to a pacifier.

Another object of the invention is to provide a pacifier holder that is safe and does not interfere with the child's ability to use the pacifier.

Another object of the invention is to provide a pacifier holder that allows the pacifier to be easily removed from the holder.

A further object of the invention is to provide a pacifier holder that is easy to clean.

Another object of the invention is to provide a pacifier holder that can clamp firmly, without twisting, on the frame of a chair, bed or stroller and accommodate a range frame cross sectional dimensions.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed pacifier holder comprising: a clamping device, a pacifier, a pacifier holder ring, a flexible wire form, a wire form to pacifier connector member, a polyfoam tube covering said flexible wire form, said wire form terminating at each end in a threaded portion, one said threaded portion engaging with female threads in said connector member, the other said threaded portion terminating in said clamping device, said connector member having an outer male thread portion that can engage a mating female thread portion centrally located on the rear of said pacifier holder ring, said pacifier holder ring including a circular base plate and a side perimeter ring, and said side perimeter ring having a plurality of flexible fingers capable of removably retaining said pacifier.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention in use on a stroller.

FIG. 2 is an exploded view of the invention.

FIG. 3 is a partial exploded view of the clamp to wire form connection.

FIG. 4 is a partial exploded view of the pacifier holder to wire form connection.

FIG. 5 is a perspective view of a pacifier being removed from the pacifier holder.

FIG. 6 is a perspective view of a unique clamping mechanism for the pacifier holder.

FIG. 7 is a side view of the unique clamping mechanism for the pacifier holder.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

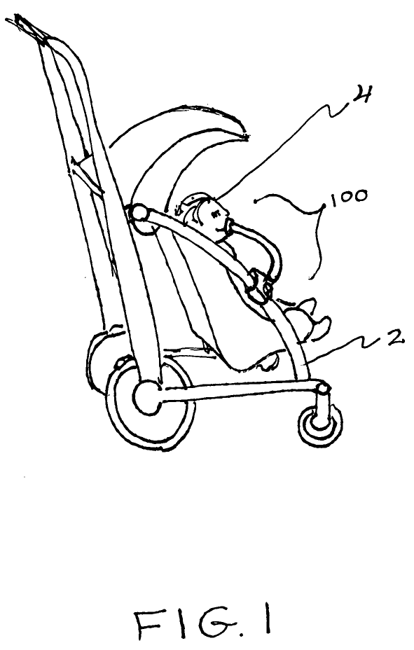

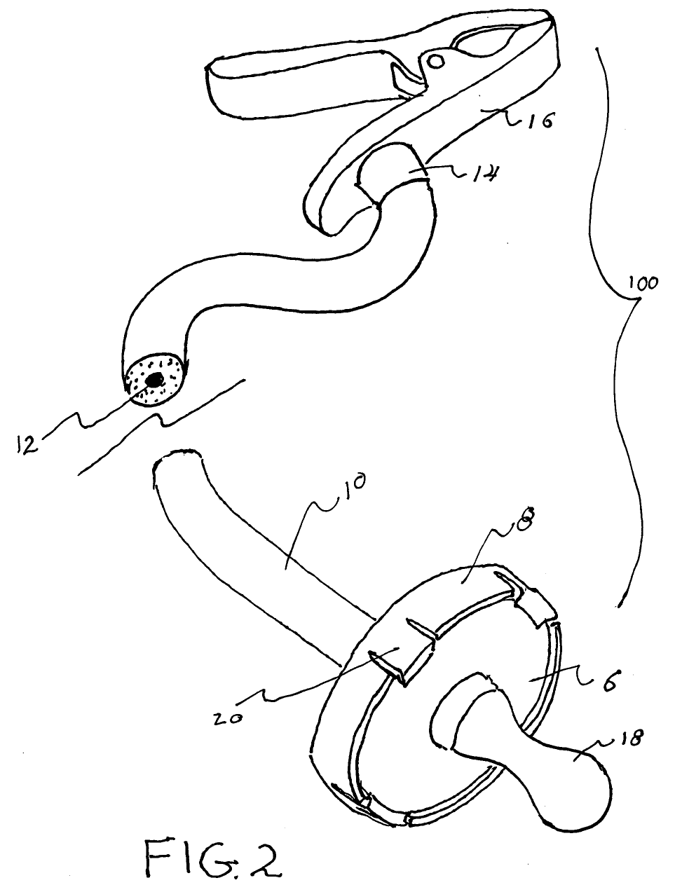

Referring now to FIG. 1 we see the pacifier holder 100 of the present invention clamped onto a standard stroller. The invention 100 allows an infant 4 to use the pacifier in a hands free position and when not in use, the pacifier remains within sight and close proximity to the infant 4. FIG. 2 shows an exploded view of the invention 100. A pacifier nipple 18 and face plate 6 are connected in a standard way. The face plate, or base plate 6 is round so that it can be fit into the holding ring 8 without needing to orient the pacifier to a particular angle. The flexible fingers 20 on the side ring 8 of the holder allows the pacifier base plate 6 to be inserted and removed by a care giver as needed. The pacifier holder is connected to a flexible wire form 12 that is coated with a polyfoam cover 10. The opposite end of the wire form is attached to a threaded boss located on standard clamp 16.

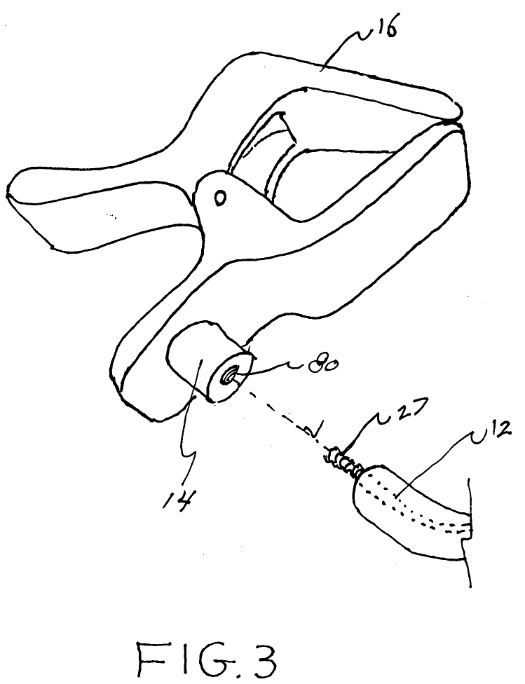

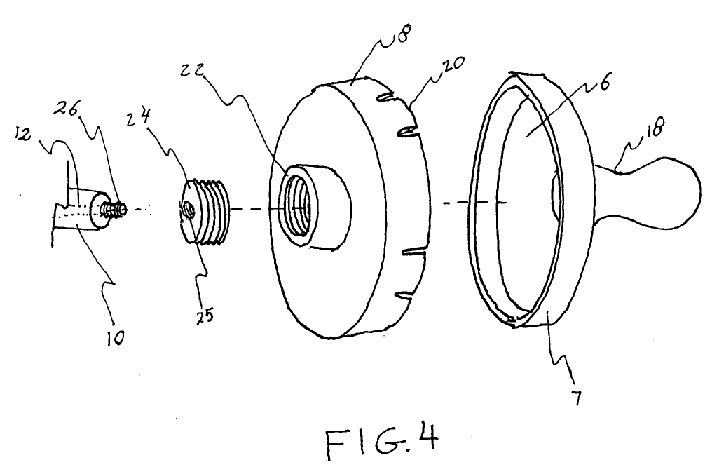

FIG. 3 shows how the threaded portion 27 of wire form 12 is engaged by female threaded portion 80 in boss 14. FIG. 4 shows an exploded view of the pacifier end of the

invention. Pacifier base plate and side ring 7 removably snaps into pacifier holder 8. Connector member 24 has a male threaded portion on its exterior that can mate with female threaded portion 22 on the back of holder 8. a female threaded portion 25 in connector 24 mates with male threaded portion 26 of wire form 12. In this way, a care giver can unscrew the connector member from the pacifier holder and clean the pacifier holder independently of the rest of the wire form 12 and clamp 16.

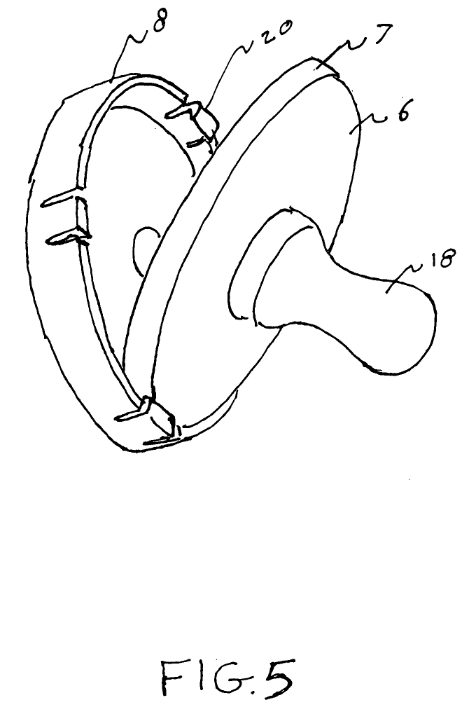

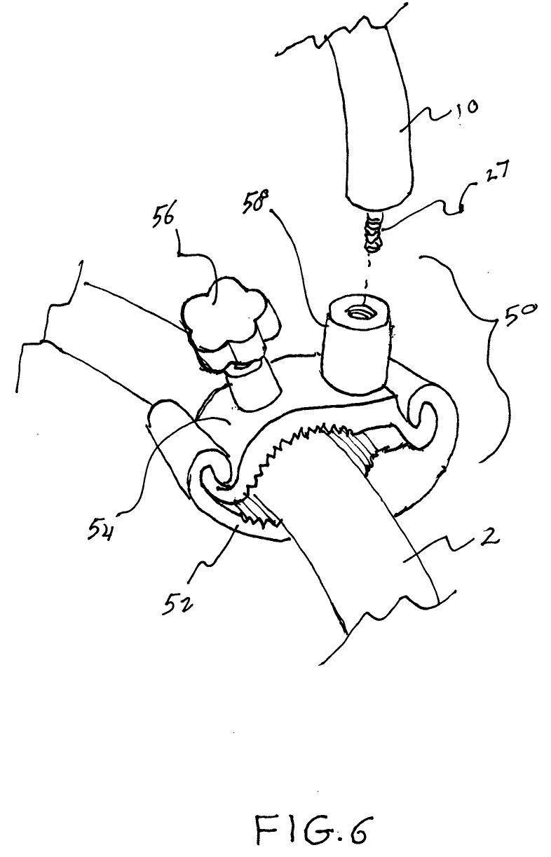

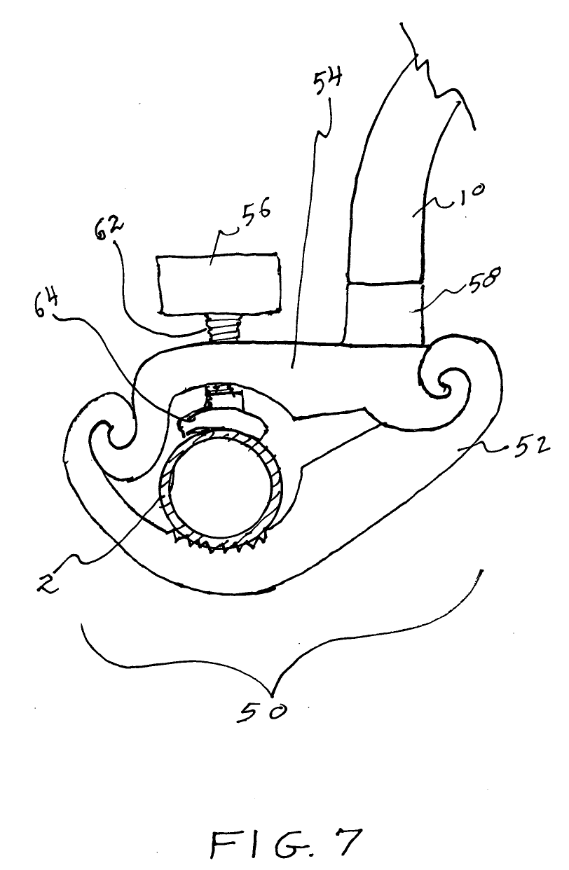

FIG. 5 shows clearly how the pacifier base plate 7 and side ring 7 removably engages from pacifier holding ring 8 with its flexible fingers 20. FIG. 6 is a perspective view of a unique clamping mechanism 50 that allows the invention 100 to be clamped firmly onto the frame of a chair, stroller or bed without twisting. The clamp 50 includes a top plate 54 and a bottom plate 52. They are slidably attached by the interlocking of the wings of top plate 54 with the C shaped end members of bottom plate 52. The threaded end 27 of the wire form threads into mating female threads in boss 58. The user attaches the top and bottom plates 54, 52 around a frame 2 of a chair, stroller or bed and turns on knob 56 which causes a threaded post to bear down on the frame member 2. FIG. 7 is a side view of clamp 50 and more clearly shows the threaded post 62 and the crescent shaped clamping member 64 that can bear down on frame member 2 with enough force that the clamp 50 will not twist during use.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. pacifier holder comprising:
a clamping device;
a pacifier;
a pacifier holder ring;
a flexible wire form;
a wire form to pacifier connector member;
a polyfoam tube covering said flexible wire form;
said wire form terminating at each end in a threaded portion;
one said threaded portion engaging with female threads in said connector member;
the other said threaded portion terminating in said clamping device;
said connector member having an outer male thread portion that can engage a mating female thread portion centrally located on the rear of said pacifier holder ring;
said pacifier holder ring including a circular base plate and a side perimeter ring; and
said side perimeter ring having a plurality of flexible fingers capable of removably retaining said pacifier.

2. pacifier holder as claimed in claim 1 wherein said clamping device is comprised of a top plate, a bottom plate;
said top plate including upwardly facing wings on each end of said plate;
said top plate also including two female threaded portions, one for inserting said threaded wire form and the other for inserting a male threaded tightening bolt;
said tightening bolt terminating in a crescent shaped clamp member
said bottom plate terminating at each end in a C shape that can slidably engage said wings of said top plate so that when said top plate and said bottom plate are engaged, a person can turn said tightening bolt and force said clamp member onto a frame member of a chair, stroller or bed.
